(19) United States
(12) Patent Application Publication
(10) Pub. No.: US 2011/0021217 A1
(43) Pub. Date: Jan. 27, 2011

(54) Short Message-Based Terminal Communication Systems and Methods

(75) Inventors: Kuo-Hsien Wang, Taipei (TW); Kuang Yi Chang, Taipei (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: JYT, INC., Taipei (TW)

(21) Appl. No.: 12/841,766

(22) Filed: Jul. 22, 2010

(30) Foreign Application Priority Data
Jul. 23, 2009 (TW) 98124850

(51) Int. Cl. H04W 4/14

(52) U.S. Cl. 455/466

(57) ABSTRACT

Short message-based terminal communication systems and methods are provided. The system includes a transmission terminal, a central server, and at least one reception terminal. The transmission terminal generates a short message, and transmits the short message to the central server. The short message includes a service identifier, an application parameter, contents, and at least one reception terminal. The central server parses the short message, and transmits the short message to the at least one reception terminal. After the short message is received, the reception terminal determines whether the service identifier conforms to a predefined service identifier. If so, the reception terminal launches a specific application procedure according to the application parameter, and displays the contents of the short message in the specific application procedure.

### CROSS REFERENCE TO RELATED APPLICATIONS

This Application claims priority of Taiwan Patent Application No. 098124850, filed on Jul. 23, 2009, the entirety of which is incorporated by reference herein.

### BACKGROUND OF THE INVENTION

1. Field of the Invention

The disclosure relates generally to short message-based terminal communication systems and methods, and, more particularly to systems and methods that can perform communications and applications among several terminals using short messages.

2. Description of the Related Art

Recently, due to increased convenience of handheld devices, such as mobile phones, and various applications developed by handheld device providers, these devices have become basic necessities of life.

A short message service (SMS) is one of the main applications of mobile phones. Users can send a short message to one or more specific users via a mobile phone. Generally, the mobile phone only displays the short message in the display unit of the mobile phone. After the short message is received, a specific user can view the content of the short message via the display unit, and determine whether to reply to the sender with a short message. However, the ability to perform additional processes to short messages is limited as such functions are not conventionally available on most mobile phones.

Additionally and conventionally, functions such as management of short messages are also not conventionally available on most mobile phones, such that respective short messages sent by users are independent. For example, short messages with the same subject matter are not able to be classified together. Additionally, for short messages with the same subject matter, communication thereof among several users cannot be performed. For example, several mobile phone users cannot conveniently communicate with each other concerning short messages with the same subject matter as they may do in a network chat room. Conventionally, communication among several mobile phone users concerning short messages with the same subject matter requires a large number of short messages. Thus, for related users, in addition to increased costs, difficulty arises when trying to manage all of the short message. Additionally, large number of short messages by users burden telecommunication systems and related networks.

Accordingly, some advanced mobile phones provide email services. Thus, users can use the mobile phone to edit and transmit email messages to other users. However, some mobile phones only having the short message service are not able to perform email transmission functions. Since short message services and email services are independent services, and no integration mechanism therebetween is provided, the inducement for users to use related services is reduced.

### BRIEF SUMMARY OF THE INVENTION

Short message-based terminal communication systems and methods are provided.

An embodiment of a short message-based terminal communication system includes a transmission terminal, a central server, and at least one reception terminal. The transmission terminal generates a short message, and transmits the short message to the central server. The short message includes a service identifier, an application parameter, contents, and information of at least one reception terminal. The central server parses the short message, and transmits the short message to the at least one reception terminal. After the short message is received, the reception terminal determines whether the service identifier conforms to a predefined service identifier. If the service identifier conforms to the predefined service identifier, the reception terminal launches a specific application procedure according to the application parameter, and displays the contents of the short message in the specific application procedure.

An embodiment of a short message-based terminal communication system includes a transmission terminal, a central server, and at least one reception terminal. The transmission terminal generates a short message, and transmits the short message to the central server. The short message at least includes contents and information of at least one reception terminal. The central server parses the short message, retrieves at least one corresponding email address according to the information of the at least one reception terminal, and generates an email message according to the contents of the short message. The central server transmits the email message to the at least one reception terminal according to the at least one email address via a network.

In an embodiment of a short message-based terminal communication method, a short message is received by a central server from a transmission terminal, wherein the short message includes a service identifier, an application parameter, contents, and information of at least one reception terminal. Then, the central server parses the short message, and transmits the short message to the at least one reception terminal. After the short message is received, the reception terminal determines whether the service identifier conforms to a predefined service identifier. If the service identifier conforms to the predefined service identifier, the reception terminal launches a specific application procedure according to the application parameter, and displays the contents of the short message in the specific application procedure.

In an embodiment of a short message-based terminal communication method, a short message is received by a central server from a transmission terminal, wherein the short message includes contents and information of at least one reception terminal. Then, the short message is parsed, at least one corresponding email address is retrieved according to the information of the at least one reception terminal, and an email message is generated according to the contents of the short message. Then, the email message is transmitted to the at least one reception terminal according to the at least one email address via a network.

In some embodiments, the short message can be divided into several sub-messages, and respectively assigned with a code, wherein the codes indicate a connection relationship among the sub-messages The reception terminal can combine the sub-messages according to the respective codes to obtain the short message.

Short message-based terminal communication methods may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of a short message-based terminal communication system of the invention;

FIG. 2 is a schematic diagram illustrating an embodiment of a terminal of the invention;

FIG. 3 is a schematic diagram illustrating an embodiment of a service management program of the invention;

FIG. 4 is a schematic diagram illustrating an embodiment of a central server of the invention;

FIG. 5 is a flowchart of an embodiment of a short message-based terminal communication method of the invention;

FIGS. 6A and 6B are flowcharts of an embodiment of a chat room application of the invention; and

FIG. 7 is a flowchart of an embodiment of a short message-based terminal communication method of the invention.

### DETAILED DESCRIPTION OF THE INVENTION

Short message-based terminal communication systems and methods are provided.

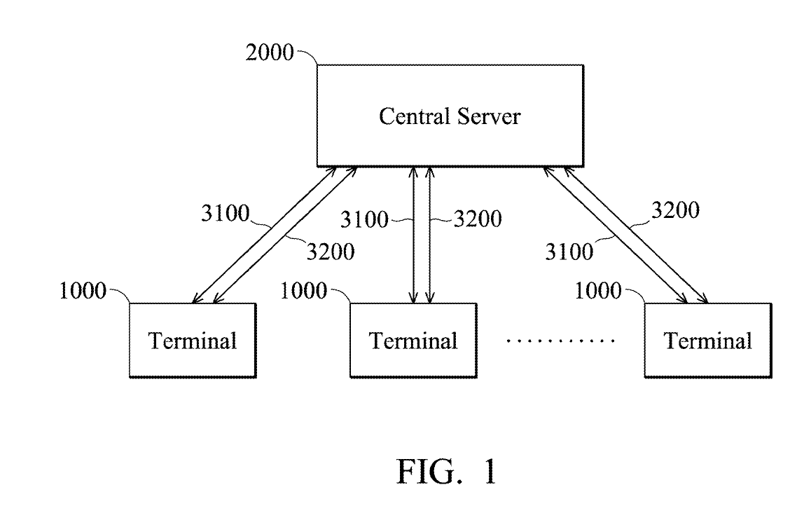

FIG. 1 is a schematic diagram illustrating an embodiment of a short message-based terminal communication system of the invention. The short message-based terminal communication system comprises a plurality of terminals 1000, such as handhelds devices comprising computer systems and mobile phones. The respective terminals 1000 can couple to a central server 2000 via a telecommunication network 3100 or a network (wired or wireless) 3200. The terminals 1000 can communicate with each other via the central server 2000 using short messages.

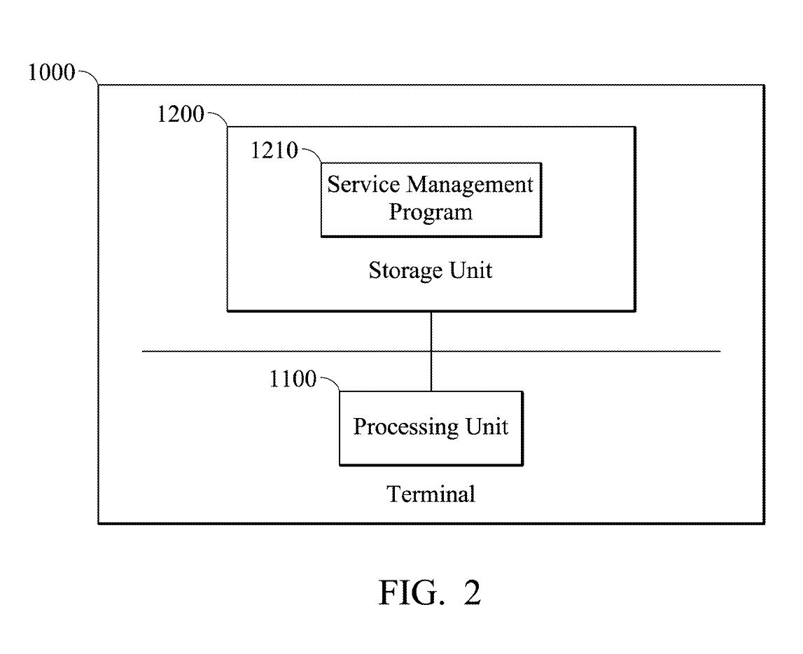

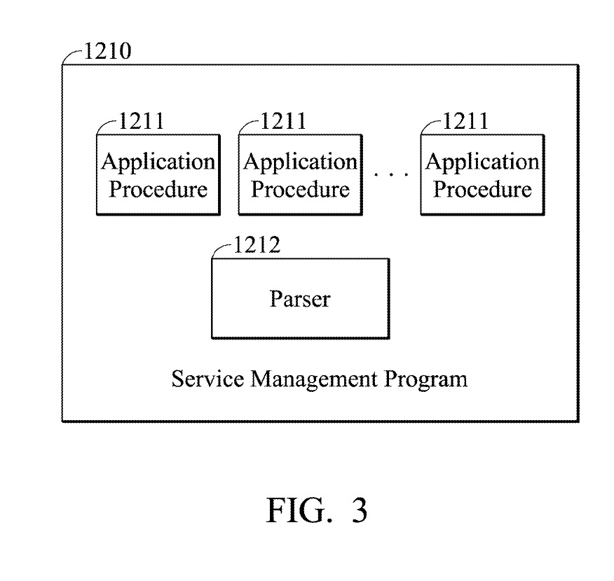

FIG. 2 is a schematic diagram illustrating an embodiment of a terminal of the invention. The terminal 1000 comprises a processing unit 1100 and a storage unit 1200. The storage unit 1200 can comprise a service management program 1210. The processing unit 1100 can execute the service management program 1210, and perform related operations on the terminal 1000. The service management program 1210 can comprise a parser 1212 and at least one application procedure 1211, as shown in FIG. 3. The parser 1212 can parse the received short message, to know related information in the short message. Each application procedure 1211 can perform various applications, such as a chat room application and a questionnaire application based on short messages. Each application procedure 1211 can also automatically perform editing of short messages corresponding to the respective applications. It is understood that, the service management program 1210 can record a predefined service identifier, and each application procedure 1211 has an application parameter. Additionally, in some embodiments, the information in the short message can comprise a service identifier, an application parameter, contents, and at least one reception terminal (information of the reception terminal). The use of the predefined service identifier and the application parameter is discussed later.

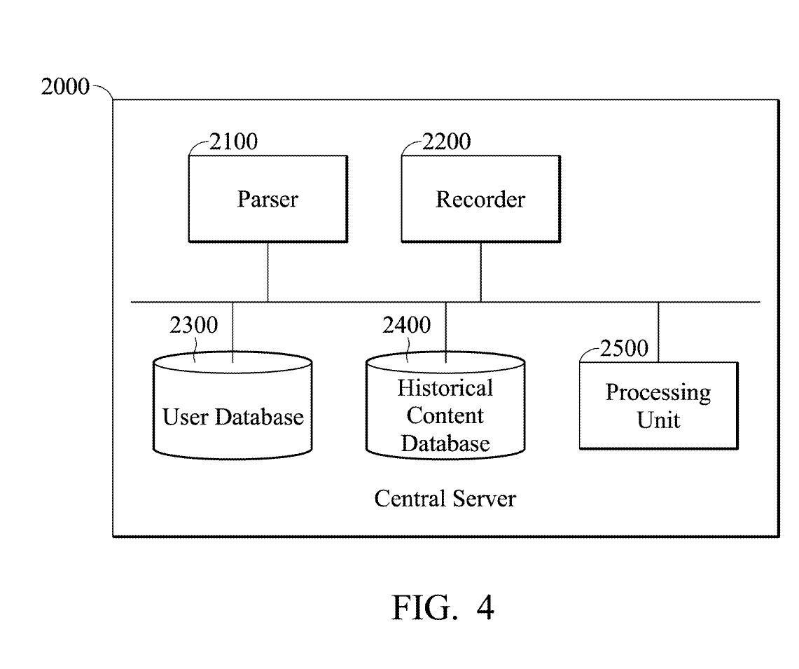

FIG. 4 is a schematic diagram illustrating an embodiment of a central server of the invention. As shown in FIG. 4, the central server 2000 comprises a parser 2100, a recorder 2200, a user database 2300, a historical content database 2400, and a processing unit 2500. Similarly, the parser 2100 can parse the received short message, to know related information in the short message. The recorder 2200 can record the short messages received by the central server 2000, and store the short messages to the historical content database 2400. It is understood that, in some embodiments, the short messages in the historical content database 2400 can be managed. For example, the short messages can be classified, sorted, and integrated based on the application parameter, contents, reception terminal, and/or time. The user database 2300 records user information, such as a telecommunication code (phone number), and/or an email address, corresponding to respective users/terminals 1000. It is understood that, the central server 2000 can have a specific telecommunication code, and the service management program 1210 in each terminal 1000 can record the specific telecommunication code. The processing unit 2500 can perform related operations on the central server 2000, which will be discussed further in the following paragraphs.

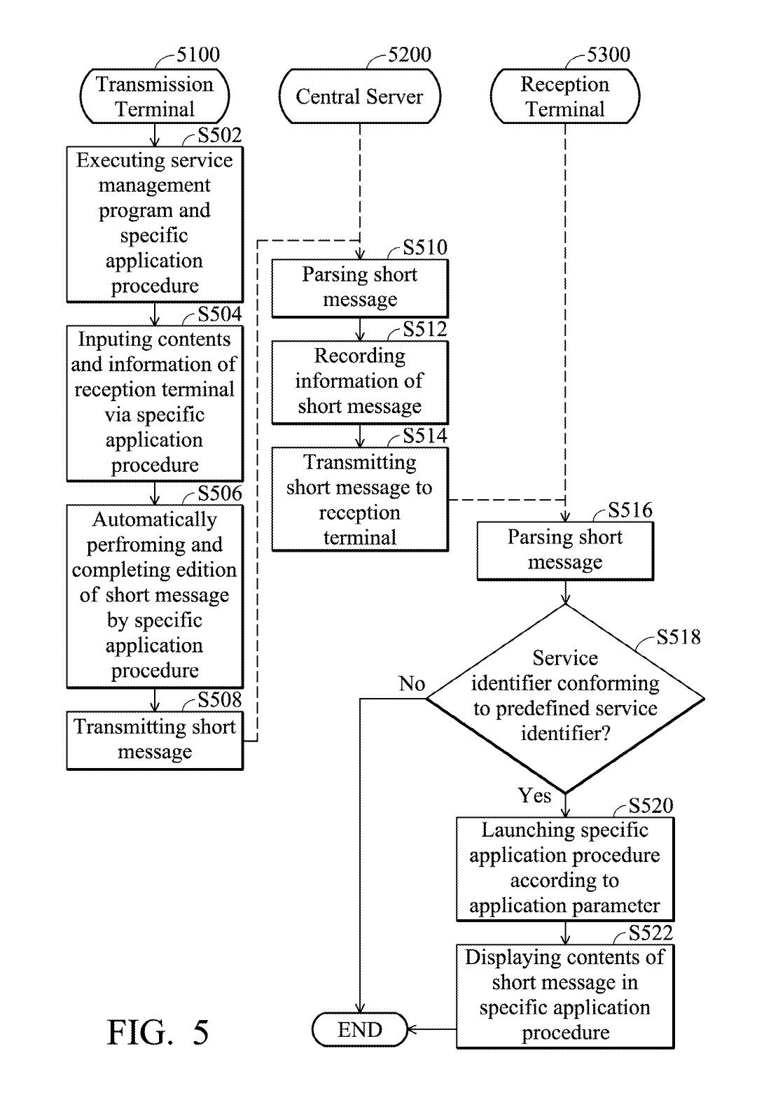

FIG. 5 is a flowchart of an embodiment of a short message-based terminal communication method of the invention.

In step S502, a transmission terminal 5100 executes a service management program 1210 and selects a specific application procedure 1211. In step S504, contents and information of at least one reception terminal 5300 of a short message are input via the specific application procedure 1211. It is understood that, the input of the information of the reception terminal 5300 can be performed by selection via a terminal list. After the contents and the information of the reception terminal 5300 are input, in step S506, the specific application procedure 1211 automatically performs and completes the editing of the short message. It is noted that, the specific application procedure 1211 can package the contents, the information of the reception terminal 5300, the service identifier corresponding to the service management program 1210, and the application parameter corresponding to the specific application procedure 1211 as the short message, according to a specific format. After the short message is generated, in step S508, the short message is transmitted according to the specific telecommunication code corresponding to the central server 5200 via a telecommunication network and at least one telecommunication service provider. It is understood that, conventionally, the length of a short message has a limitation. In some embodiments, the short message can be divided into several sub-messages, and respectively assigned with a code, such as binary code. The connection of the sub-messages can be controlled and managed according to the respective codes. For example, a short message can be divided into X sub-messages, and each sub-message will record a code indicating that the sub-message is the Y-th sub-message within the X sub-messages. The sub-messages can be transmitted according to the specific telecommunication code corresponding to the central server 5200 via a telecommunication network and at least one telecommunication service provider.

After the central server 5200 receives the short message from the transmission terminal 5100, in step S510, the central server 5200 parses the short message to obtain related information of the short message, and in step S512, records the related information of the short message. Then, in step S514, the short message is transmitted to the reception terminal 5300 according to the information of the reception terminal 5300 recorded in the short message. Similarly, the central server 5200 can transmit the short message to the reception terminal 5300 via a telecommunication network and at least one telecommunication service provider. It is understood that, in some embodiments, the central server 5200 can perform a corresponding operation, such as a specific function according to the application parameter recorded in the short message.

After the reception terminal 5300 receives the short message, in step S516, the reception terminal 5300 parses the short message to obtain the related information of the short message, and in step S518, determines whether the service identifier recorded in the short message conforms to a predefined service identifier preset in the reception terminal 5300. If the service identifier does not conform to the predefined service identifier (No in step S518), the procedure is terminated; that is, the short message is processed using the conventional manner. If the service identifier conforms to the predefined service identifier (Yes in step S518), in step S520, the reception terminal 5300 launches a specific application procedure according to the application parameter recorded in the short message, and in step S522, displays the contents of the short message in the specific application procedure. It is understood that, in some embodiments, the reception terminal 5300 can determine whether the service management program 1210 has been activated or not. If the service management program 1210 has not been activated, the service management program 1210 can be activated for subsequent determinations and operations.

As described, in some embodiments, the short message may be divided into several sub-messages. It is understood that, the reception terminal can know whether all of the sub-messages have been received according to the codes recorded in the sub-messages. When the reception terminal receives all of the sub-messages, the reception terminal can combine the sub-messages according to the respective codes to obtain the short message.

It is noted that, as described, each terminal can couple to the central server via the network. In some embodiments, the central server 5200 can determine whether the reception terminal 5300 is coupled to the central server 5200 via the network. When the reception terminal 5300 is not coupled to the central server 5200 via the network, the central server 5200 can transmit the short message to the reception terminal 5300 via the telecommunication network. When the reception terminal 5300 is coupled to the central server 5200 via the network, the central server 5200 can directly notify the reception terminal 5300 with the short message via the network. Additionally, the user database 2300 can record the email address corresponding to the respective reception terminal 5300. In some embodiments, the central server 5200 can retrieve a corresponding email address according to the information of the reception terminal 5300, generate an email message according to the short message, and transmit the email message to an email box of the reception terminal 5300 according to the retrieved email address via the network. Note that, in some embodiments, the central server 5200 can simultaneously transmit the short message to the reception terminal 5300 via the telecommunication network and transmit the email message to the email box of the reception terminal 5300 via the network. However, in some embodiments, the central server 5200 may transmit the email message to the email box of the reception terminal 5300 according to the email address of the reception terminal 5300 via the network when the reception terminal is not coupled to the central server.

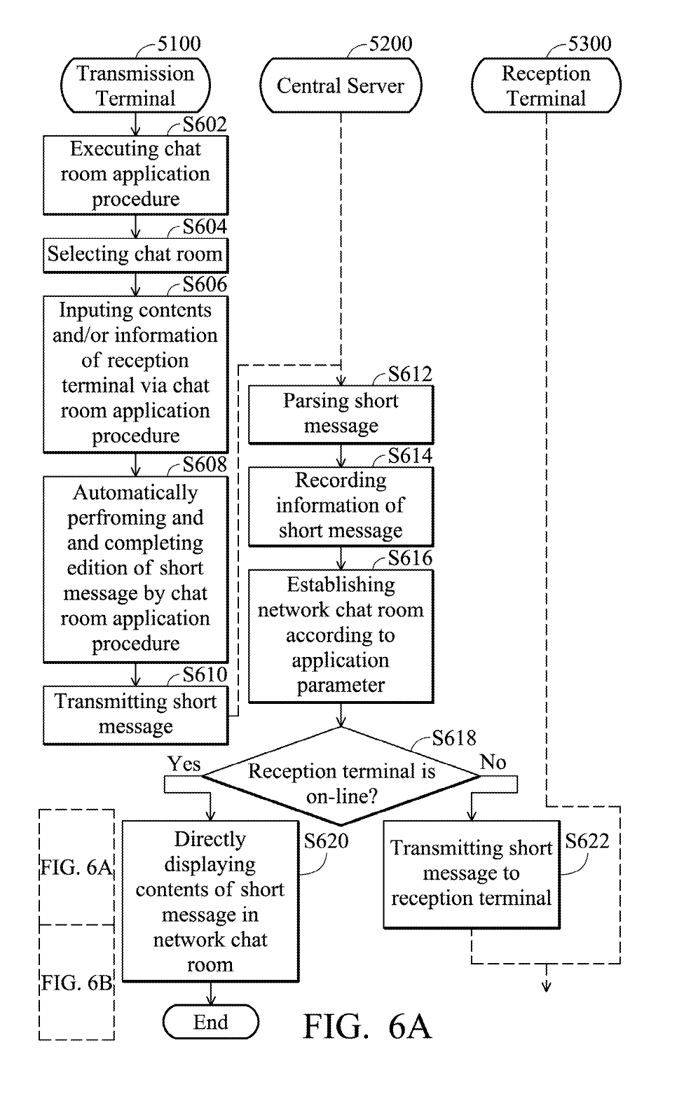

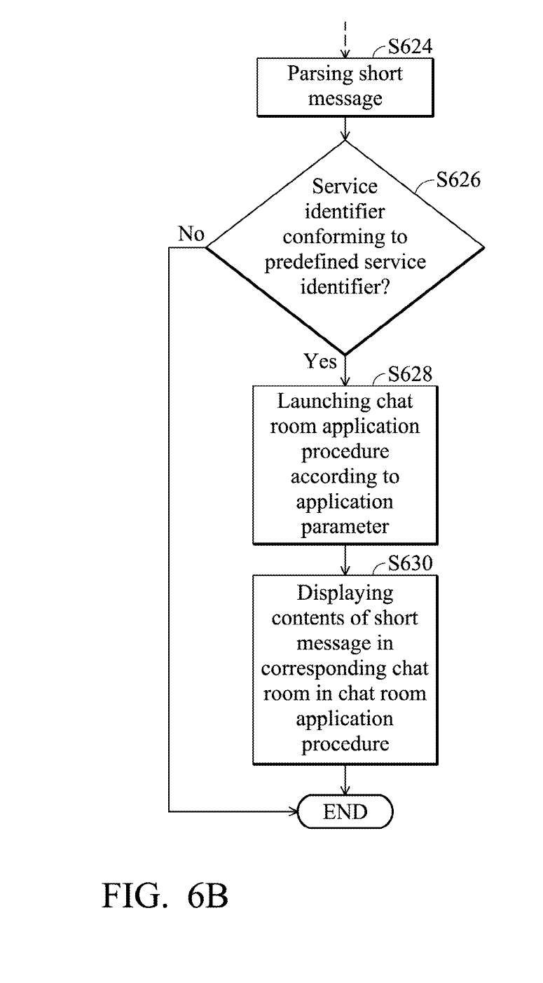

FIGS. 6A and 6B are flowcharts of an embodiment of a chat room application of the invention.

In step S602, a transmission terminal 5100 executes a service management program 1210 and selects a chat room application procedure, and in step S604, a user of the transmission terminal 5100 selects or establishes a chat room. In step S606, contents and/or information of at least one reception terminal 5300 are input via the chat room application procedure. It is understood that, when the transmission terminal 5100 is an originator of the chat room, the user must input the information of the reception terminal 5300. When the transmission terminal 5100 is not the originator of the chat room, the input of the information of the reception terminal 5300 can be omitted. After the contents and/or the information of the reception terminal 5300 are input, in step S608, the chat room application procedure automatically performs and completes the editing of a short message. Similarly, the chat room application procedure can package the contents, the information of the reception terminal 5300, the service identifier corresponding to the service management program 1210, and the application parameter corresponding to the chat room application procedure, and an identification of the chat room as the short message, according to a specific format. After the short message is generated, in step S610, the short message is transmitted according to the specific telecommunication code corresponding to the central server 5200 via a telecommunication network and at least one telecommunication service provider.

After the central server 5200 receives the short message from the transmission terminal 5100, in step S612, the central server 5200 parses the short message to obtain related information of the short message, and in step S614, records the related information of the short message. Then, in step S616, a network chat room is established according to the application parameter corresponding to the chat room application procedure, and in step S618, it is determined whether the reception terminal 5300 is on-line (the reception terminal 5300 is coupled to the central server 5200 via the network). When the reception terminal 5300 is coupled to the central server 5200 via the network (Yes in step S618), in step S620, the central server 5200 directly displays the contents of the short message in the network chat room. When the reception terminal 5300 is not coupled to the central server 5200 via the network (No in step S618), in step S622, the central server 5200 transmits the short message to the reception terminal 5300 according to the information of the reception terminal 5300 recorded in the short message. Similarly, the central server 5200 can transmit the short message to the reception terminal 5300 via a telecommunication network and at least one telecommunication service provider.

After the reception terminal 5300 receives the short message, in step S624, the reception terminal 5300 parses the short message to obtain the related information of the short message, and in step S626, determines whether the service identifier recorded in the short message conforms to a predefined service identifier preset in the reception terminal 5300. If the service identifier does not conform to the predefined service identifier (No in step S626), the procedure is terminated. If the service identifier conforms to the predefined service identifier (Yes in step S626), in step S628, the reception terminal 5300 launches the chat room application procedure according to the application parameter recorded in the short message, and in step S630, displays the contents of the short message in a chat room corresponding to the chat room identification in the chat room application procedure. Similarly, in some embodiments, the reception terminal 5300 can determine whether the service management program 1210 has been activated or not. If the service management program 1210 has not been activated, the service management program 1210 can be activated for subsequent determinations and operations.

It is understood that, the application procedure 1211 in the service management program 1210 can be designed according to various requirements. For example, in some embodiments, the application procedure 1211 can be a questionnaire application procedure. Users can edit at least one question and information of at least one reception terminal via the questionnaire application procedure. The questionnaire application procedure can automatically package the question, the information of the reception terminal, the service identifier, and the application parameter corresponding to the questionnaire application procedure as a short message, and transmit the short message to the reception terminal via the central server. In some embodiments, the central server can gather statistics according to the short message replied from the at least one reception terminal, and transmit the statistical results to the transmission terminal. Further, in some embodiments, the central server can determine whether the short message replied from all of the reception terminals are received. If the short message replied from all of the reception terminals are received, the central server transmits the statistical results to the transmission terminal. Note that, the chat room application and the questionnaire application are only examples of the present application, and the present invention is not limited thereto. Any application containing communication among terminals based on short messages can be applied in the present invention.

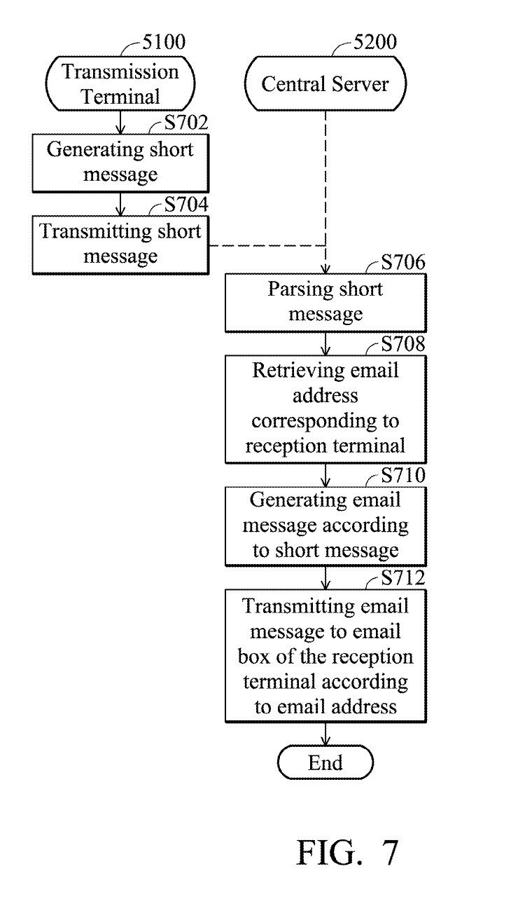

FIG. 7 is a flowchart of an embodiment of a short message-based terminal communication method of the invention. In this embodiment, the short message service and the email service are integrated.

In step S702, a transmission terminal 5100 generates a short message. Similarly, the short message can be edited using the application procedure 1211 in the service management program 1210. The short message comprises contents and information of at least one reception terminal. After the short message is generated, in step S704, the short message is transmitted according to the specific telecommunication code corresponding to the central server 5200 via a telecommunication network and at least one telecommunication service provider. After the central server 5200 receives the short message from the transmission terminal 5100, in step S706, the central server 5200 parses the short message to obtain related information of the short message. Then, in step S708, the central server 5200 retrieves a corresponding email address from the user database according to the information of the reception terminal 5300, and in step 5710, generates an email message according to the contents of the short message. In step 5712, the central server 5200 transmits the email message to an email box of the reception terminal 5300 according to the retrieved email address via the network. Similarly, in some embodiments, the short message can be divided into several sub-messages, and respectively assigned with a code. The central server 5200 can combine the sub-messages according to the respective codes to obtain the short message.

Therefore, the short message-based terminal communication systems and methods can perform communications and applications among terminals using short messages; thus, increasing the applicability of short messages, and reducing costs, and decreasing the burden on telecommunications systems and related networks, required for performing the applications. The short message service and the email service can be integrated based on the present invention; thus, providing a more convenient service.

Short message-based terminal communication methods, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed:

1. A short message-based terminal communication system, comprising:
a transmission terminal generating a short message, and transmitting the short message, wherein the short message comprises a service identifier, an application parameter, contents, and information of at least one reception terminal; and
a central server receiving the short message from the transmission terminal, parsing the short message, and transmitting the short message to the at least one reception terminal,
wherein the at least one reception terminal receives the short message, determines whether the service identifier conforms to a predefined service identifier, and if the service identifier conforms to the predefined service identifier, the at least one reception terminal launches a specific application procedure according to the application parameter, and displays the contents of the short message in the specific application procedure.

2. The system of claim 1, wherein the central server transmits the short message to the at least one reception terminal via a telecommunication network.

3. The system of claim 2, wherein the central server further determines whether the at least one reception terminal is coupled to the central server via a network, and when the at least one reception terminal is not coupled to the central server via the network, the central server transmits the short message to the at least one reception terminal via the telecommunication network.

4. The system of claim 2, wherein when a specific reception terminal among the at least one reception terminal receives the short message, the specific reception terminal further edits a reply short message, and transmits the reply short message to the transmission terminal and the at least one reception terminal except for the specific reception terminal via the central server, wherein the reply short message comprises the service identifier, the application parameter, reply contents, and information of the transmission terminal and the at least one reception terminal except for the specific reception terminal.

5. The system of claim 4, wherein the specific application procedure is a chat room application procedure, and after the specific reception terminal inputs the reply contents in the specific application procedure, the specific application procedure automatically performs and completes the editing of the reply short message.

6. The system of claim 4, wherein the central server further records the contents of the short message and the reply contents of the reply short message.

7. The system of claim 4, wherein the central server further establishes a network chat room, and determines whether the transmission terminal or the at least one reception terminal except for the specific reception terminal is coupled to the central server via a network, and when the transmission terminal or the at least one reception terminal except for the specific reception terminal is coupled to the central server via the network, the central server displays the reply contents of the reply short message in the network chat room.

8. The system of claim 2, wherein the specific application procedure is a questionnaire application procedure, and after the at least one reception terminal receives the short message, the at least one reception terminal further edits a reply short message, and transmits the reply short message to the transmission terminal via the central server, wherein the reply short message comprises the service identifier, the application parameter, reply contents, and information of the transmission terminal.

9. The system of claim 8, wherein the central server further gathers statistics based on the reply short message received from the at least one reception terminal, and transmits a statistical results to the transmission terminal.

10. The system of claim 9, wherein the central server further determines whether the reply short message from the respective reception terminal has been received, and if the reply short message from the respective reception terminal has been received, the central server transmits the statistical results to the transmission terminal.

11. The system of claim 1, wherein the at least one reception terminal further determines whether a service management program has been activated, and if the service management program has not been activated, the at least one reception terminal activates the service management program to determine whether the service identifier conforms to the predefined service identifier, and perform subsequent operations.

12. The system of claim 1, wherein the central server further retrieves at least one email address according to the information of the at least one reception terminal, generates an email message according to the short message, and transmits the email message to the at least one reception terminal according to the at least one email address via a network.

13. The system of claim 12, wherein the central server further determines whether the at least one reception terminal is coupled to the central server via a network, and when the at least one reception terminal is not coupled to the central server via the network, the central server retrieves the at least one email address according to the information of the at least one reception terminal, generates the email message according to the short message, and transmits the email message to the at least one reception terminal according to the at least one email address via the network.

14. The system of claim 1, wherein the short message further comprises a specific telecommunication code corresponding to the central server, and the short message is transmitted to the central server according to the specific telecommunication code via at least one telecommunication service provider.

15. The system of claim 1, wherein the transmission terminal further divides the short message into several sub-messages, and respectively assigns a code to the respective sub-message, wherein the at least one reception terminal combines the sub-messages according to the respective codes to obtain the short message.

16. A short message-based terminal communication system, comprising:
a transmission terminal generating a short message, and transmitting the short message, wherein the short message comprises contents and information of at least one reception terminal; and
a central server receiving the short message from the transmission terminal, parsing the short message, retrieving at least one corresponding email address according to the information of the at least one reception terminal, generating an email message according to the contents of the short message, and transmitting the email message to the at least one reception terminal according to the at least one email address via a network.

17. A short message-based terminal communication method, comprising:
receiving a short message from a transmission terminal by a central server, wherein the short message comprises a service identifier, an application parameter, contents, and information of at least one reception terminal;
parsing the short message, and transmitting the short message to the at least one reception terminal by the central server;
determining whether the service identifier conforms to a predefined service identifier by the at least one reception terminal; and
if the service identifier conforms to the predefined service identifier, launching a specific application procedure according to the application parameter, and displaying the contents of the short message in the specific application procedure by the at least one reception terminal.

18. The method of claim 17, wherein the central server transmits the short message to the at least one reception terminal via a telecommunication network.

19. The method of claim 18, further comprising:
determining whether the at least one reception terminal is coupled to the central server via a network by the central server; and
when the at least one reception terminal is not coupled to the central server via the network, transmitting the short message to the at least one reception terminal via the telecommunication network by the central server.

20. The method of claim 18, further comprising when a specific reception terminal among the at least one reception terminal receives the short message, editing a reply short message, and transmitting the reply short message to the transmission terminal and the at least one reception terminal except for the specific reception terminal via the central server by the specific reception terminal, wherein the reply short message comprises the service identifier, the application parameter, reply contents, and information of the transmission terminal and the at least one reception terminal except for the specific reception terminal.

21. The method of claim 20, wherein the specific application procedure is a chat room application procedure, and after the specific reception terminal inputs the reply contents in the specific application procedure, the specific application procedure automatically performs and completes the editing of the reply short message.

22. The method of claim 20, further comprising recording the contents of the short message and the reply contents of the reply short message by the central server.

23. The method of claim 20, further comprising:
establishing a network chat room by the central server;
determining whether the transmission terminal or the at least one reception terminal except for the specific reception terminal is coupled to the central server via a network by the central server; and
when the transmission terminal or the at least one reception terminal except for the specific reception terminal is coupled to the central server via the network, displaying the reply contents of the reply short message in the network chat room by the central server.

24. The method of claim 18, wherein the specific application procedure is a questionnaire application procedure, and the method further comprises a step of after the at least one reception terminal receives the short message, editing a reply short message, and transmits the reply short message to the transmission terminal via the central server by the at least one reception terminal, wherein the reply short message comprises the service identifier, the application parameter, reply contents, and information of the transmission terminal.

25. The method of claim 24, further comprising:
gathering statistics based on the reply short message received from the at least one reception terminal by the central server; and
transmitting a statistical results to the transmission terminal by the central server.

26. The method of claim 25, further comprising:
determining whether the reply short message from the respective reception terminal has been received by the central server; and
if the reply short message from the respective reception terminal has been received, transmitting the statistical results to the transmission terminal by the central server.

27. The method of claim 17, further comprising:
determining whether a service management program has been activated by the at least one reception terminal; and
if the service management program has not been activated, activating the service management program, by the at least one reception terminal, to determine whether the service identifier conforms to the predefined service identifier, and perform subsequent operations.

28. The method of claim 17, further comprising:
retrieving at least one email address according to the information of the at least one reception terminal by the central server;
generating an email message according to the short message by the central server; and
transmitting the email message to the at least one reception terminal according to the at least one email address via a network by the central server.

29. The method of claim 28, further comprising:
determining whether the at least one reception terminal is coupled to the central server via a network by the central server; and
when the at least one reception terminal is not coupled to the central server via the network, retrieving the at least one email address according to the information of the at least one reception terminal, generating the email message according to the short message, and transmitting the email message to the at least one reception terminal according to the at least one email address via the network by the central server.

30. The method of claim 17, wherein the short message further comprises a specific telecommunication code corresponding to the central server, and the short message is transmitted to the central server according to the specific telecommunication code via at least one telecommunication service provider.

31. The method of claim 17, further comprising dividing the short message into several sub-messages, and respectively assigning a code to the respective sub-message by the transmission terminal, wherein the at least one reception terminal combines the sub-messages according to the respective codes to obtain the short message.

32. A short message-based terminal communication method, comprising:
receiving a short message from a transmission terminal by a central server, wherein the short message comprises contents and information of at least one reception terminal;
parsing the short message by the central server;
retrieving at least one corresponding email address according to the information of the at least one reception terminal by the central server;
generating an email message according to the contents of the short message by the central server; and
transmitting the email message to the at least one reception terminal according to the at least one email address via a network by the central server.

33. A machine-readable storage medium comprising a computer program, which, when executed, causes a device to perform a short message-based terminal communication method, wherein the method comprises:
receiving a short message from a transmission terminal, wherein the short message comprises a service identifier, an application parameter, contents, and information of at least one reception terminal; and
parsing the short message, and transmitting the short message to the at least one reception terminal,
wherein the at least one reception terminal determines whether the service identifier conforms to a predefined service identifier, and if the service identifier conforms to the predefined service identifier, the at least one reception terminal launches a specific application procedure according to the application parameter, and displays the contents of the short message in the specific application procedure.

34. A machine-readable storage medium comprising a computer program, which, when executed, causes a device to perform a short message-based terminal communication method, wherein the method comprises:
receiving a short message from a transmission terminal, wherein the short message comprises contents and information of at least one reception terminal;
parsing the short message;
retrieving at least one corresponding email address according to the information of the at least one reception terminal;
generating an email message according to the contents of the short message; and
transmitting the email message to the at least one reception terminal according to the at least one email address via a network.
